(19) United States
(12) Patent Application Publication
(10) Pub. No.: US 2014/0301824 A1
(43) Pub. Date: Oct. 9, 2014

(54) WIND POWER GENERATION APPARATUS

(71) Applicant: Zhi-Xuan YU, Taichung (TW)

(72) Inventor: Zhi-Xuan YU, Taichung (TW)

(21) Appl. No.: 14/309,413

(22) Filed: Jun. 19, 2014

Related U.S. Application Data
(63) Continuation-in-part of application No. 13/160,157, filed on Jun. 14, 2011.

(51) Int. Cl. F03D 1/04

(52) U.S. Cl. CPC F03D 1/04
USPC 415/4.5; 415/191

(57) ABSTRACT

A wind power generation apparatus includes a wind guiding structure, a rotary structure, a rotary shaft and a wind collecting hood. The wind collecting hood forms an airflow passage. The rotary shaft is located in the airflow passage. The rotary structure is mounted on the rotary shaft. The wind guiding structure is securely mounted on the wind collecting hood, and at a front end of the rotary structure. The wind guiding structure includes multiple airflow guiding vanes each having a windward portion, a leeward portion, and a curved portion between the windward portion and the leeward portion. A shortest distance between the windward portions of any two adjacent airflow guiding vanes is greater than a shortest distance between the leeward portions of the two adjacent airflow guiding vanes. An airflow having passed through the airflow passage is accelerated and converted to a swirling airflow by the curved portion.

This application is a continuation-in-part, and claims priority, of from U.S. patent application Ser. No. 13/160,157 filed on Jun. 14, 2011, entitled “WIND POWER GENERATION APPARATUS”, the entire contents of which are hereby incorporated by reference.

### FIELD OF THE INVENTION

The present invention relates to a wind power generation apparatus, and more particularly, to a wind power generation apparatus including an airflow accelerating guide for reducing starting wind power.

### BACKGROUND OF THE INVENTION

Wind power generation is the purest natural renewable power source, hence is widely accepted by environmental activists. Many types of wind power generation techniques have been proposed in prior art, such as Taiwan Patents Nos. M296920 disclosing “Thermal Wind Power Generation Apparatus”, M307718 disclosing “Vehicle Wind Power Generation Apparatus”, M326072 disclosing “Self-assembly Wind Power Generation Wall”, and M329580 disclosing “Flow guiding structure to reduce wind resistance”, U.S. Pat. No. 7,255,527 disclosing “Wind Power Generator”, U.S. Pat. No. 7,094,018 disclosing “Wind Power Generator” and U.S. Pat. No. 4,348,594 disclosing “Wind Power Generator”, and U.S. Application Publication 2009/0261596 disclosing “Wind Power Generator”. In the above disclosures, electric energy is generated from wind power through different blade structures, and the efficiency of wind power generation is reinforced through different blade structures and electric power generating structures. Being zero-pollution and having low installation costs, the apparatuses of the above disclosures are well-received by the public.

In all of the aforesaid wind power generation apparatuses, blades are driven and rotated via kinetic energy of wind, and the blades then drive a power generator to spin to generate electric power. In order to drive the blades to rotate, wind must reach a certain strength level that is generally called starting wind power.

One of most baffling problems encountered by conventional wind power generation apparatuses is that wind generated in most residential areas and environments cannot maintain at a power level greater than that of the starting wind for a long period of time. As a result, the conventional wind power generation apparatuses may become useless or generate only negligible amount of electric power. Such drawback greatly reduces the application scope of wind power generation.

### SUMMARY OF THE INVENTION

Therefore, the primary object of the present invention is to provide a wind power generation apparatus operable with small starting wind power to increase installation possibility and applicability of the wind power generation apparatus.

To achieve the foregoing object, the present invention provides a wind power generation apparatus that includes a wind collecting hood, a rotary shaft, a rotary structure and a wind guiding structure. The wind collecting hood is a hollow circular barrel and forms an airflow passage. The rotary shaft is located in the airflow passage of the wind collecting hood. The rotary structure includes a plurality of airflow receiving blades which are mounted the rotary shaft in a spread manner. The wind guiding structure includes a plurality of airflow guiding vanes arranged in a spread manner and abutting a front end of the rotary structure, such that the airflow guiding vanes are securely fastened to the wind collecting hood. Each of the airflow guiding vanes includes a windward portion, a leeward portion, and a curved portion between the windward portion and the leeward portion. A shortest distance between the windward portions of any two adjacent airflow guiding vanes is greater than a shortest distance between the leeward portions of the two adjacent airflow guiding vanes, so as to accelerate the airflow, and to further convert the accelerated airflow to a swirling airflow by the curved portions.

By means of the construction set forth above, the present invention provides many advantages. To name one of the advantages, the wind guiding structure can guide the direction of the airflow entering from the airflow passage, and accelerate the airflow to form a swirling airflow that directly blows the rotary structure at optimal angles and drives the rotary structure to rotate. Thus, the rotary structure can be driven and rotated by a small amount of wind. That is to say, with the wind power generation apparatus of the present invention, while the starting wind power is reduced, the efficiency and amount of energy of wind power generation are increased, thereby expanding the application scope of wind power generation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention;

FIG. 2 is a sectional view of the present invention;

FIG. 3 is a schematic view of airflow guiding of the present invention;

FIG. 4 is a schematic view of another structure of airflow receiving blades of the present invention;

FIG. 5A is a schematic view showing positions of different sites in the present invention;

FIG. 5B is a schematic diagram of an airflow pressure of the present invention;

FIG. 5C is a schematic diagram of a speed distribution of the present invention;

FIG. 6A to FIG. 6C are schematic diagrams of rotational speed, torque and output power respectively under wind speeds of 3, 6 and 12 m/s according to an embodiment of the present invention;

FIG. 7 is a schematic diagram of output power corresponding to different wind speeds of the present invention; and

FIG. 8 is a schematic diagram of airflow guiding according to another embodiment of the present invention.

### DETAILED DESCRIPTION OF THE PREFERRED EMBODIMENTS

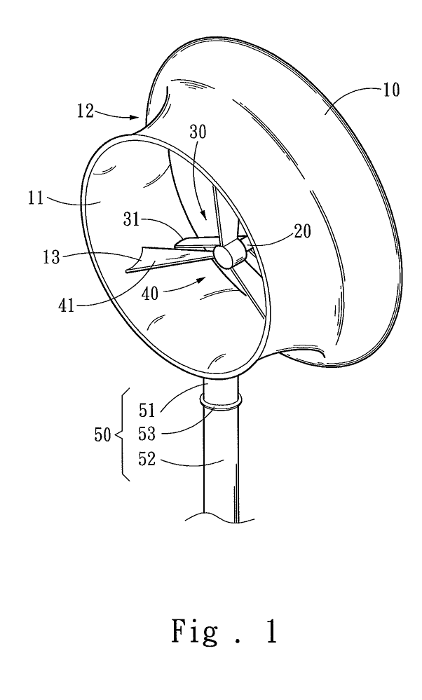

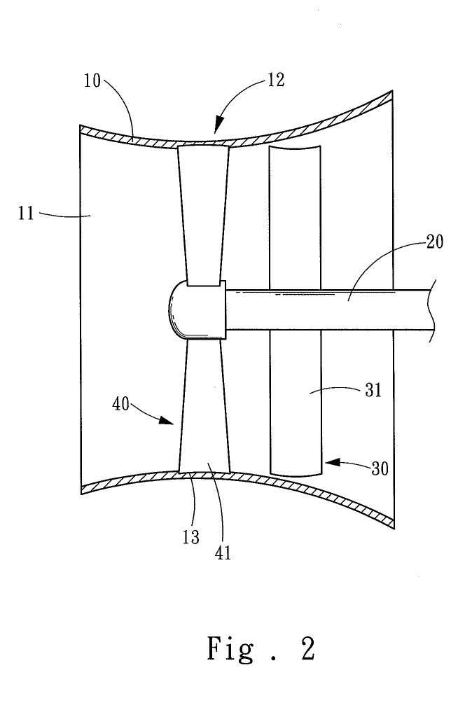

Referring to FIG. 1 and FIG. 2, the present invention aims to provide a wind power generation apparatus. The wind power generation apparatus includes a wind collecting hood 10, a rotary shaft 20, a rotary structure 30 and a wind guiding structure 40. The wind collecting hood 10 is a hollow circular barrel and forms an airflow passage 11, and has a diameter that gradually shrinks from two ends of the wind collecting hood 10 towards a center of the wind collecting hood 10 to form a neck portion 12.

The wind collecting hood 10 may be mounted on an upright post 50. The upright post 50 includes a rotary portion 51 and a holding portion 52 that are bridged by a rotary bearing 53, in a way that the rotary portion 51 is rotatable relative to the holding portion 52.

The rotary shaft 20 drives a power generator (not shown) held in the airflow passage 11 of the wind collecting hood 10. The rotary structure 30 includes a plurality of airflow receiving blades 31 which are mounted the rotary shaft 20 in a spread manner. The wind guiding structure 40 includes a plurality of airflow guiding vanes 41 arranged in a spread manner and abutting a front end of the rotary structure 30. The wind collecting hood 10 has a plurality of latch grooves 13 inserted by the airflow guiding vanes 41 to form secured positioning to the wind collecting hood 10. The rotary shaft 20 has one end pivotally connected to the wind guiding structure 40.

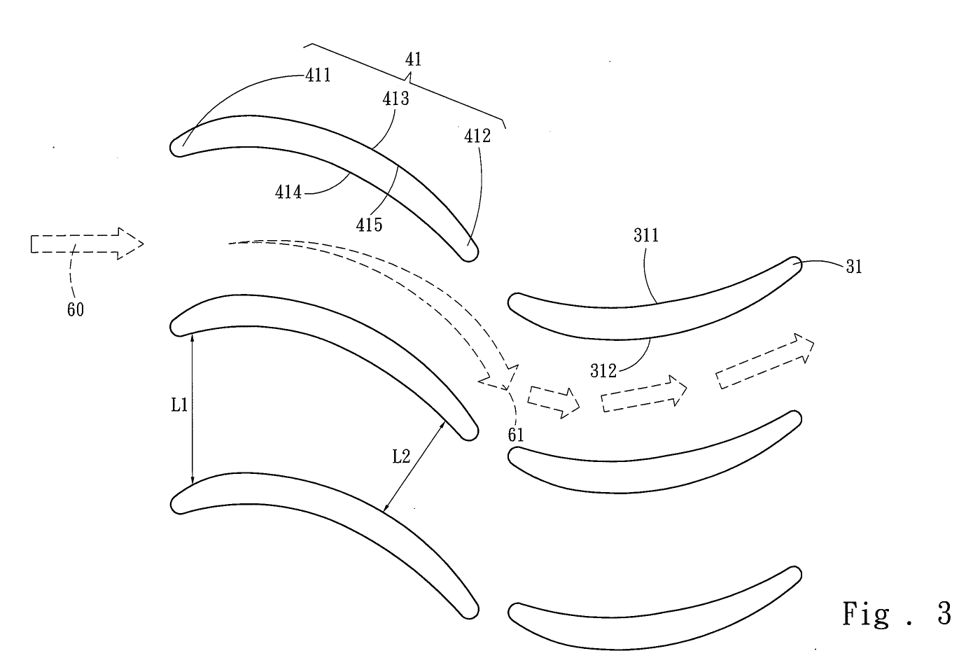

FIG. 3 shows a schematic view of airflow guiding of the present invention. Referring to FIG. 3, the airflow guiding vanes 41 and the airflow receiving blades 31 are arranged in an encircling and spread manner in the airflow passage 11 to guide the airflow. Each of the airflow guiding vanes 41 includes a windward portion 411, a leeward portion 412, and a curved portion 413 disposed between the windward portion 411 and the leeward portion 412. A shortest distance L1 between the windward portions 411 of any two adjacent airflow guiding vanes 41 is greater than a shortest distance L2 between the leeward portions 412 of the two adjacent airflow guiding vanes 41. In the embodiment, by adjusting angles of the airflow guiding vanes 41, angles of the leeward portions 412 can be adjusted to reduce an area through which an airflow 60 passes in the airflow passage 11 to further accelerate the airflow 60. Further, each of the airflow guiding vanes 41 includes a first inward curved surface 414, and a first outward curved surface 415 opposite the first inward curved surface 414 to provide a rotating curvature.

After having been accelerated, the airflow 60 is received by the first inward curved surfaces 414 to change a direction of the airflow 60, such that the airflow 60 is converted to a swirling airflow 61.

Each of the airflow receiving blades 31 similarly includes a second inward curved surface 311, and a second outward curved surface 312 opposite the second inward curved surface 311 to provide an inverse rotating curvature. The second inward curved surfaces 311 are for receiving the swirling airflow 61.

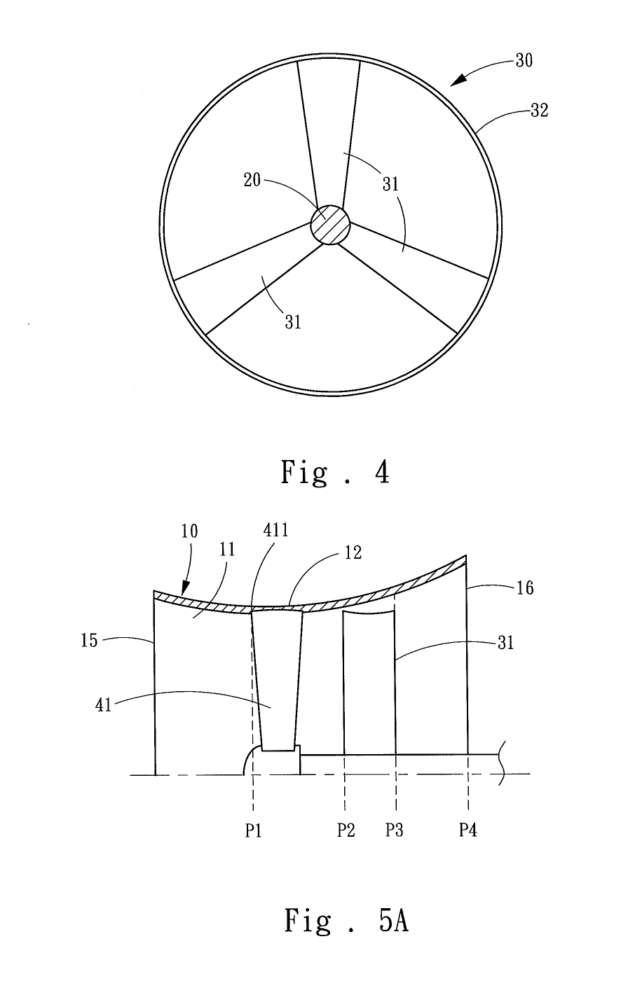

FIG. 4 shows a schematic diagram of airflow receiving blades according to another embodiment of the present invention. Referring to FIG. 4, the rotary structure 30 further includes a driven ring 32 connected to the airflow receiving blades 31 at positions remote from the center thereof The driven ring 32 is formed at a desired thickness to increase mechanical rotating efficiency of the airflow receiving blades 31 when the airflow receiving blades 31 receive the swirling airflow 61.

By means of the structure set forth above, the airflow 60 passing through the airflow passage 11 is directed by the airflow guiding vanes 41 to become the swirling airflow 61, which directly blows the airflow receiving blades 31 at optimal angles to rotate. Thus, the rotary structure 30 can be driven and rotated by a small wind input to be operable at small starting wind power. As a result, the wind power generation apparatus of the present invention can be widely installed at various sites to provide steady and continuous power.

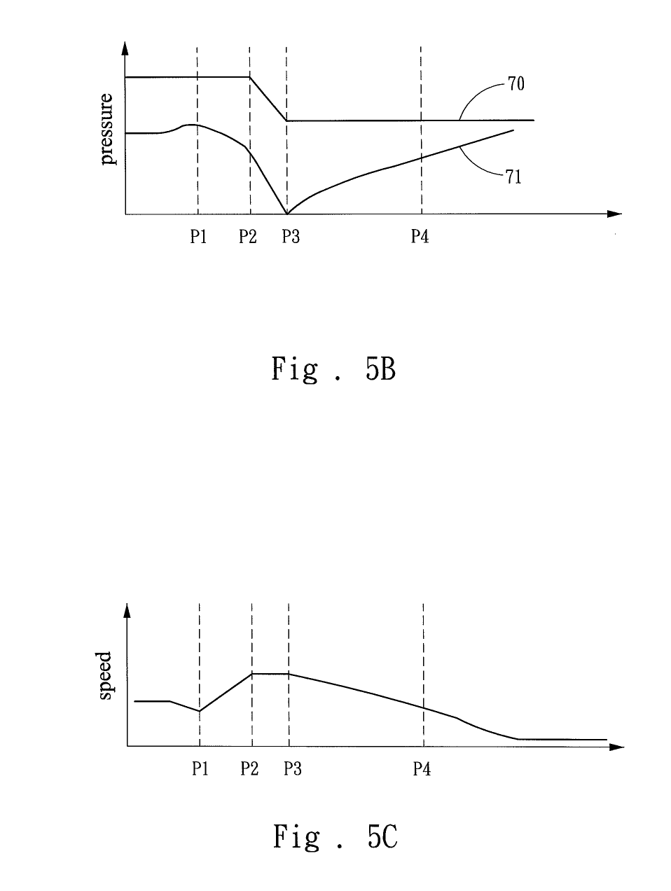

Referring to FIGS. 5A, 5B and 5C, a first site P1 is a position at the windward portion 411 of the airflow guiding vane 41, a second site P2 is a position at the airflow receiving blade 31 near a wind inlet 15, a third site P3 is a position at the airflow receiving blade 31 remote from the wind inlet 15, and a fourth site P4 is a position at a wind outlet 16 of the wind collecting hood 10. It should be noted that, two lines in FIG. 5B respectively represent a full-pressure line 70 and a static-pressure line 71. The static pressure represents the atmospheric pressure in a windless condition. A wind pressure that causes the air to flow due to two different static pressures is referred to as the dynamic pressure. The full pressure is the sum of the static pressure and the dynamic pressure. After the airflow 60 enters the first site P1, due to the shrinking diameter of the wind collecting hood 10 as well as the guiding and acceleration contributed by the airflow guiding vane 41, the flowing speed of the airflow 60 is accelerated. Further, being divided and guided by the airflow guiding vane 41, the airflow 60 is converted to the swirling airflow 61. Between the second site P2 and the third site P3, energy of the swirling airflow 61 is absorbed by the airflow receiving blade 31 receiving the swirling airflow 61 and is converted into electric power, such that the full-pressure line 71 and the static-pressure line 71 are both lowered. After the fourth site P4, the static pressure gradually restores to being slightly lower than the static pressure at the first site P1, and restores to substantially the same as the pressure at the first site P1 as gradually getting farther away from the fourth site P4. With the consumption in the dynamic pressure, the full pressure becomes slightly lower than the full pressure at the site P1. It is clearly observed from FIGS. 5b and 5c that, the wind speed at the wind inlet before the first site P1 and after passing through the airflow guiding vane 41 is noticeably and effectively increased.

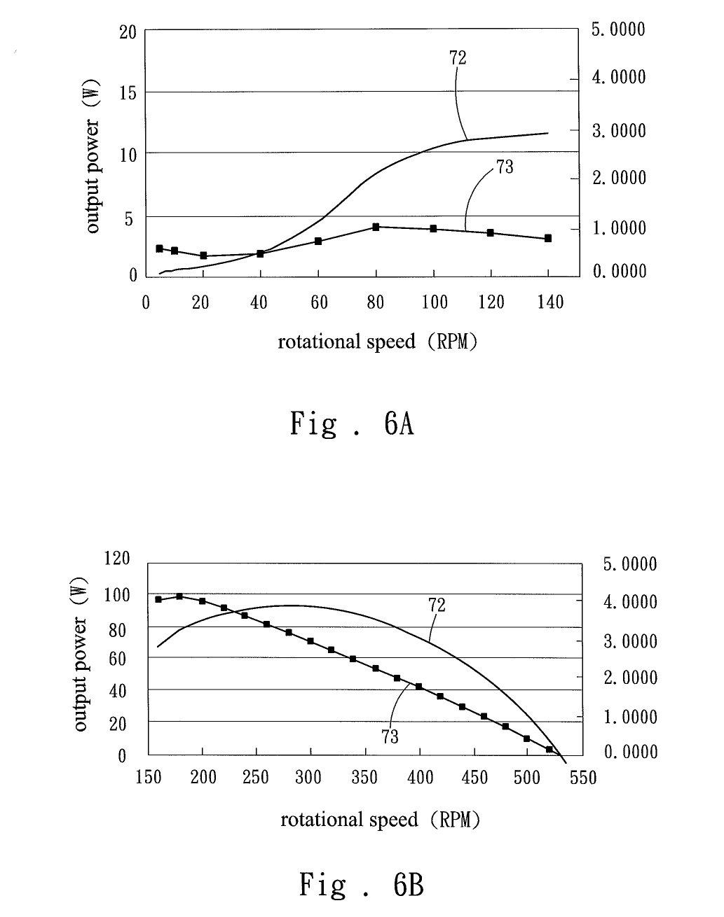

FIG. 6A to FIG. 6C are schematic diagrams of the rotational speed, torque and output power under wind speeds of 3, 6 and 12 m/s according to a preferred embodiment of the present invention, respectively. With the wind collecting hood 10 and the accelerating and guiding effects of the airflow guiding vanes 41, the swirling airflow 61 is faster than the speed of the airflow 60 entering the air collecting hood 10. In the embodiment, the wind speed refers to the speed of the airflow 60 before reaching the airflow guiding vanes 41. As shown, tests using different rotational speeds are conducted to identify the optimal wind conversion performance. The different rotational speeds may indicate that different rotary power generators or power generating apparatuses are applied. In FIG. 6A, as the speed of the airflow is quite slow, it is seen that a torque line 73 does not change at a large scale. Thus, the output power of an output power line 72 is larger as the rotational speed gets higher. In FIG. 6B, the torque line 73 decreases as the rotational speed increases, and thus the output power is preferred when the rotational speed is 280 RPM. In FIG. 6C, the output power is preferred when the rotational speed is 570 RPM.

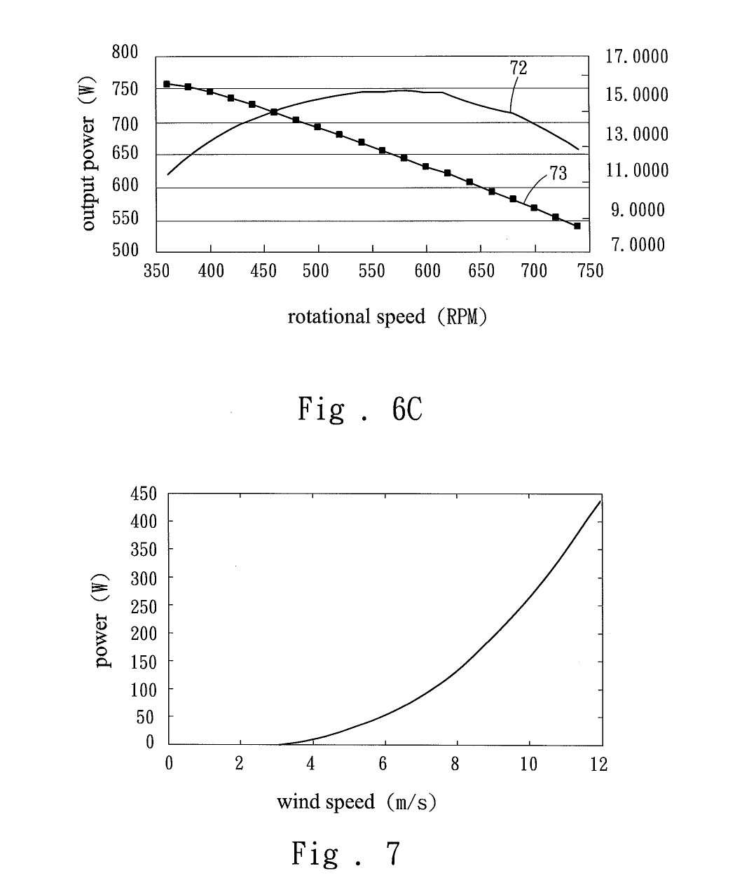

FIG. 7 shows a schematic diagram of output power corresponding to different wind speeds according to a preferred embodiment of the present invention. As shown, the design of the present invention is capable of yielding 10 W power even when the wind speed is only 3 m/s, and approximately 60 W power when the wind speed is 6 m/s. It is demonstrated that the design of the present invention effectively reduces the starting wind power, and offers efficient operations even when given a slow wind speed.

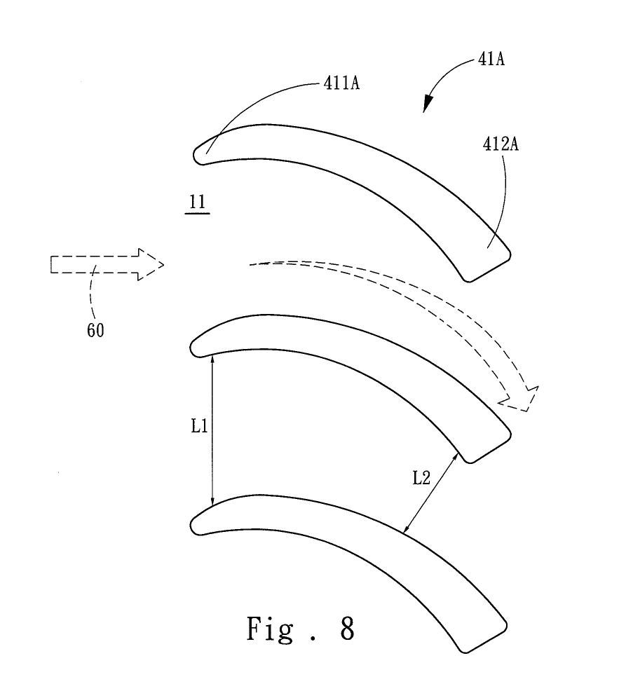

FIG. 8 shows a schematic diagram of airflow guiding according to another embodiment of the present invention. In the embodiment, by adjusting a thickness of a leeward portion 412A to be greater than that of the windward portion 411A, the shortest distance L1 between the windward portions 411 A of any two airflow guiding vanes 41A is similarly rendered to be greater than the shortest distance between the leeward portions 412A of the two adjacent airflow guiding vanes 41A, thereby achieving the effect of accelerating the airflow 60.

In short, in the present invention, the airflow is guided towards desired directions to accelerate and form the swirling airflow, which then directly blows the airflow receiving blades at the optimal angles to rotate the airflow receiving blades.

With the structure set forth above, the present invention provides the following features. First of all, the swirling airflow formed by the plurality of airflow guiding vanes drives the airflow receiving blades at preferred incoming angles, so as to reduce the starting wind power and enhance the efficiency of wind power generation of the wind power generation apparatus.

As the shortest distance between the windward portions of any two adjacent airflow guiding vanes is greater than the shortest distance between the leeward portions of the two adjacent airflow guiding vanes, the airflow having passed through the airflow guiding vanes is accelerated to drive the airflow receiving blades.

Further, with the driving ring, mechanical rotating efficiency is increased.

Therefore, in addition to reducing the starting power wind, the present invention also enhances the efficiency and increases the amount of wind power generation, thereby expanding the application scope of wind power generation.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A wind power generation apparatus, comprising:
a wind collecting hood, being a hollow circular barrel, forming an airflow passage;
a rotary shaft, located in the airflow passage of the wind collecting hood;
a rotary structure, comprising a plurality of airflow receiving blades which are mounted on the rotary shaft in a spread manner; and
a wind guiding structure, abutting a front end of the rotary structure, comprising:
a plurality of airflow guiding vanes arranged in a spread manner and securely fastened to the wind collecting hood, each of the airflow guiding vanes comprising a windward portion, a leeward portion, a curved portion between the windward portion and the leeward portion; a shortest distance between the wind receiving portions of any two adjacent airflow guiding vanes being greater than a shortest distance between the leeward portions of the two adjacent airflow guiding vanes.

2. The wind power generation apparatus of claim 1, wherein one end of the rotary shaft is pivotally connected to the wind guiding structure.

3. The wind power generation apparatus of claim 1, wherein each of the airflow guiding vanes comprises a first inward curved surface and a first outward curved surface opposite the first inward curved surface to form a rotating curvature; each of the airflow receiving blades comprising a second inward curved surface and a second outward curved surface opposite the second inward curved surface to form an inverse rotating curvature.

4. The wind power generation apparatus of claim 1, wherein a thickness of the leeward portion of the airflow guiding vanes is greater than that of the windward portion.

5. The wind power generation apparatus of claim 1, wherein the wind collecting hood comprises a plurality of latch grooves, into which the airflow guiding vanes are inserted to form secured positioning to the wind collecting hood.

6. The wind power generation apparatus of claim 1, wherein a diameter of the wind collecting hood gradually shrinks from two ends of the wind collecting hood towards a center of the wind collecting hood to form a neck portion.

7. The wind power generation apparatus of claim 1, wherein the wind collecting hood is mounted on an upright post.

8. The wind power generation apparatus of claim 7, wherein the upright post comprises a rotary portion and a holding portion bridged by a rotary bearing to form rotary coupling therewith.

9. The wind power generation apparatus of claim 1, wherein the rotary structure further comprises a driven ring connected to the airflow receiving blades at positions remote from a center thereof.
